(19) United States
(12) Patent Application Publication
(10) Pub. No.: US 2007/0229823 A1
(43) Pub. Date: Oct. 4, 2007

(54) Determination of the number concentration and particle size distribution of nanoparticles using dark-field microscopy

(75) Inventors: Kung-Bin Sung, Seattle, WA (US); Jingwu Zhang, San Jose, CA (US); Tae-Woong Koo, Cupertino, CA (US)

Correspondence Address: DARBY & DARBY P.C., P.O. BOX 770, Church Street Station, New York, NY, 10008-0770, US

(73) Assignee: Intel Corporation, Santa Clara, CA (US)

(21) Appl. No.: 11/393,882

(22) Filed: Mar. 31, 2006

(51) Int. Cl. G01N 15/02

(52) U.S. Cl. 356/336

(57) ABSTRACT

Embodiments of the invention relate to determining the number concentration and size distribution of particles using dark-field microscopy. These embodiments are especially useful for the simultaneous determination of particle number concentration and size distribution of particles with dimensions below 4 microns.

### FIELD OF INVENTION

The embodiments of the invention relate to methods and apparatus for determining the number concentration and size distribution of particles using dark-field microscopy. The embodiments are especially useful for the simultaneous determination of particle number concentration and size distribution of particles with dimensions below 500 nm. The invention transcends several scientific disciplines such as polymer chemistry, biochemistry, molecular biology, medicine and medical diagnostics.

### BACKGROUND

Colloidal particles, especially those with a dimension less than 100 nm, have found increasingly more applications in various industrial and medical fields in recent years. Particle number concentration (PNC) and particle size distribution (PSD) are among the most important parameters for characterizing a suspension of these particles.

The well-known Coulter Counter Technique, which can count the number of particles and determine their size distribution, only applies to particles larger than 400-500 nm. Moreover, a relatively high concentration of electrolytes (i.e. 0.5M NaCl) has to be used as the suspending media, which can cause aggregation of most types of colloidal particles. Particle counting techniques based on light-obscuration do not apply to nanoparticles either. Light scattering methods (static and dynamic light scattering) are capable of determining the size distribution of colloidal particles down to a few nanometers under favorable conditions, but they could not give accurate number concentrations unless the particles have a very narrow size distribution. More precise PSD determination for particles less than 500 nm are usually obtained by transmission electron microscopy (TEM), but sample preparation is more tedious and is prone to artifacts. Accordingly, a method for efficiently and accurately determining both particle number concentration (PNC) and particle size distribution (PSD) is needed.

In a dark-field microscope, an opaque disk is placed underneath the condense lens to prevent illumination light from directly going to the detector or viewer's eyes, therefore the background is completely dark. Only light that is scattered by objects in the sample can be detected. Dark-field microscopy is suited for visualizing small scatters such as metal or semiconductor nanoparticles. Dark-field microscopy has been applied to count the number of particles, but this technique has not been explored for determining PSD at the same time.

### BRIEF DESCRIPTION OF THE DRAWINGS

FIG. 1A shows an example of an open cell for particle counting and PSD measurement based on particle brightness.

FIG. 1B shows an example of a closed cell for PSD determination based on Brownian motion and particle brightness.

FIG. 2 shows a flow chart for processing dark-field images of nanoparticles.

FIG. 3 shows an embodiment for a continuous fluidic dark-field particle counter/sizer.

FIG. 4 shows particle detection by a continuous fluidic dark-field particle counter.

FIG. 5 shows a dark-field microscopic image of 60 nm Au particles, acquired with a 10×, NA 0.3 objective.

FIG. 6 shows an original image (left) and binary image after automated particle segmentation (right).

FIG. 7 shows the root mean square distance covered by diffusing particles and time for particles to diffuse by a distance of 1 μm in an aqueous solution at 25° C.

FIG. 8 is a depiction of the dark-field detection of nanoparticles.

### DETAILED DESCRIPTION

As used in the specification and claims, the singular forms “a”, “an” and “the” include plural references unless the context clearly dictates otherwise. For example, the term “an array” may include a plurality of arrays unless the context clearly dictates otherwise.

“Microprocessor” is a processor on an integrated circuit (IC) chip. The processor may be one or more processor on one or more IC chip. The chip is typically a silicon chip with thousands of electronic components that serves as a central processing unit (CPU) of a computer or a computing device.

A “nanomaterial” as used herein refers to a structure, a device or a system having a dimension at the atomic, molecular or macromolecular levels, in the length scale of approximately 1-100 nanometer range. Preferably, a nanomaterial has properties and functions because of the size and can be manipulated and controlled on the atomic level.

The phrase “SERS active particle refers” to particles that produce the surface-enhanced Raman scattering effect. The colloidal particles described herein may be SERS active particles. The SERS active particles generate surface enhanced Raman signal specific to the analyte molecules when the analyte-SERS complexes are excited with a light source. The enhanced Raman scattering effect provides a greatly enhanced Raman signal from Raman-active analyte molecules that have been adsorbed onto certain specially-prepared SERS active particle surfaces. Typically, the SERS active particle surfaces are metal surfaces. Increases in the intensity of Raman signal have been regularly observed on the order of 10⁴-10¹⁴ for some systems. SERS active particles include a variety of metals including coinage (Au, Ag, Cu), alkalis (Li, Na, K), Al, Pd and Pt.

The term “COIN” refers to a composite-organic-inorganic nanocluster(s)/nanoparticle(s). The COIN could be surface-enhanced Raman scattering (SERS, also referred to as surface-enhanced Raman spectroscopy)-active nanoclusters incorporated into a gel matrix and used in certain other analyte separation techniques described herein. COINs are composite organic-inorganic nanoclusters. These SERS-active probe constructs comprise a core and a surface, wherein the core comprises a metallic colloid comprising a first metal and a Raman-active organic compound. The COINs can further comprise a second metal different from the first metal, wherein the second metal forms a layer overlying the surface of the nanoparticle. The COINs can further comprise an organic layer overlying the metal layer, which organic layer comprises the probe. Suitable probes for attachment to the surface of the SERS-active nanoclusters include, without limitation, antibodies, antigens, polynucleotides, oligonucleotides, receptors, ligands, and the like.

The metal required for achieving a suitable SERS signal is inherent in the COIN, and a wide variety of Raman-active organic compounds can be incorporated into the particle. Indeed, a large number of unique Raman signatures can be created by employing nanoclusters containing Raman-active organic compounds of different structures, mixtures, and ratios. Thus, the methods described herein employing COINs are useful for the simultaneous detection of many analytes in a sample, resulting in rapid qualitative analysis of the contents of “profile” of a body fluid.

COINs could be prepared using standard metal colloid chemistry. The preparation of COINs also takes advantage of the ability of metals to adsorb organic compounds. Indeed, since Raman-active organic compounds are adsorbed onto the metal during formation of the metallic colloids, many Raman-active organic compounds can be incorporated into the COIN without requiring special attachment chemistry.

In general, the COINs could be prepared as follows. An aqueous solution is prepared containing suitable metal cations, a reducing agent, and at least one suitable Raman-active organic compound. The components of the solution are then subject to conditions that reduce the metallic cations to form neutral, colloidal metal particles. Since the formation of the metallic colloids occurs in the presence of a suitable Raman-active organic compound, the Raman-active organic compound is readily adsorbed onto the metal during colloid formation. COINs of different sizes can be enriched by centrifugation.

The COINs can include a second metal different from the first metal, wherein the second metal forms a layer overlying the surface of the nanoparticle. To prepare this type of SERS-active nanoparticle, COINs are placed in an aqueous solution containing suitable second metal cations and a reducing agent. The components of the solution are then subject to conditions that reduce the second metallic cations so as to form a metallic layer overlying the surface of the nanoparticle. In certain embodiments, the second metal layer includes metals, such as, for example, silver, gold, platinum, aluminum, and the like. Typically, COINs are clustered structures and range in size from about 50 nm to 100 nm.

Typically, organic compounds are attached to a layer of a second metal in COINs by covalently attaching organic compounds to the surface of the metal layer Covalent attachment of an organic layer to the metallic layer can be achieved in a variety ways well known to those skilled in the art, such as for example, through thiol-metal bonds. In alternative embodiments, the organic molecules attached to the metal layer can be crosslinked to form a molecular network.

The COIN(s) can include cores containing magnetic materials, such as, for example, iron oxides, and the like such that the COIN is a magnetic COIN. Magnetic COINs can be handled without centrifugation using commonly available magnetic particle handling systems. Indeed, magnetism can be used as a mechanism for separating biological targets attached to magnetic COIN particles tagged with particular biological probes.

As used herein, “Raman-active organic compound” refers to an organic molecule that produces a unique SERS signature in response to excitation by a laser. A variety of Raman-active organic compounds are contemplated for use as components in COINs. In certain embodiments, Raman-active organic compounds are polycyclic aromatic or heteroaromatic compounds. Typically the Raman-active organic compound has a molecular weight less than about 300 Daltons.

The term “fluid” used herein means an aggregate of matter that has the tendency to assume the shape of its container, for example a liquid or gas. Analytes in fluid form can include fluid suspensions and solutions of solid particle analytes.

One embodiment of the invention is a method of determining the particles size distribution of particles. The method includes measuring a scattering intensity of particles in a sample with a dark-field microscope, and correlating a brightness of the particles to a particle size distribution of the particles in the sample.

Preferably, the particles have an average particle size less than 4 microns, more preferably less than 400 nanometers. Preferably, the particles include polystyrene, latex, gold, silver, copper, iron, lithium, sodium, potassium, palladium, platinum, aluminum or a metal oxide.

A reference sample may be used to determine the correlation between the brightness of the particles and the size of the particles. The method may further include determining the particle number concentration of the sample. The particle number concentration of the sample may be determined by determining the number of particles in a sample volume

Another embodiment is a method of determining the particles size distribution of particles. The method includes obtaining a plurality of dark-field images with a dark field microscope of a sample comprising particles, and correlating positional changes of the particles in the plurality of dark-field images for a given time to a particle size distribution of the particles.

The method may further include determining the particle number concentration of the sample. The particle number concentration of the sample determined by determining the number of particles in the sample, determining a volume of the sample and dividing the number of particles in the sample by the volume of the sample.

Yet another embodiment is a device for determining the particles size distribution of particles. The device includes a cell having a closed volume with a thickness of 20 μm or less, wherein the closed volume is a predetermined fixed volume, and wherein the cell is transparent in a direction along the thickness. The device also includes a dark-field microscope, wherein the closed volume of the cell is adapted to be completely within a field of view of the dark-field microscope such that the device is adapted to determine a particle size distribution and a particle number concentration of a sample.

The device includes a cell having a thickness of 20 μm or less, wherein the cell is transparent in at least one thickness direction. The device also includes a dark-field microscope.

Preferably, the device includes an array of cells on a single substrate. Preferably, the device further includes a sample including colloidal particles within the cell. Preferably the dark-field microscope comprises a light source, an opaque disk and a condenser lens. Preferably, the dark-field microscope includes a charge coupled device (CCD) and a microprocessor. Preferably, the cell wall of the device includes glass or a gel film.

Another embodiment is a device for determining the particles size distribution of nanoparticles. The device includes a cell having a thickness of 20 μm of less, wherein the cell is transparent in a direction along the thickness. The device also includes fluid injection channels, wherein the fluid injection channels provide cites to inject a sample into the cell, and a dark-field microscope.

Preferably, the device includes an array of cells on a single substrate. Preferably, the device further includes a sample including colloidal particles within the cell. Preferably the dark-field microscope comprises a light source, an opaque disk and a condenser lens. Preferably, the dark-field microscope includes a charge coupled device (CCD) and a microprocessor. Preferably, the cell wall of the device includes glass or a gel film.

Another embodiment is a device that includes a capillary, a pump to pump a fluid containing particles through the capillary; and a dark-field microscope focused on the fluid in the capillary.

The device may also include a waste reservoir for depositing the sample once the sample has exited the capillary. Preferably, the capillary has an inner diameter of less than 90 microns.

The described methods and apparatus utilize dark filed microscopy for the simultaneous determination of number concentration and size distribution of colloidal particles, especially those with an average diameter of less than 4 microns, more preferably less than 1 micron and most preferably less than 400 nm. Preferably, the colloidal particles have an average diameter of greater than 1 micron, more preferably greater than 5 microns and most preferably greater than 10 microns.

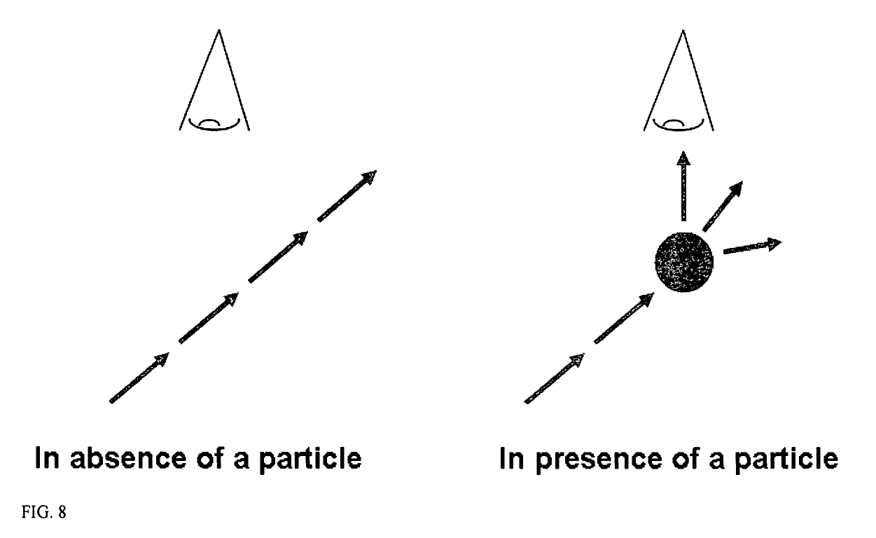

Dark-field microscopy relies on a different illumination system than standard brightfield microscopy. Rather than illuminating the sample with a filled cone of light, the condenser in a dark-field microscope is designed to form a hollow cone of light. The light at the apex of the cone is focused at the plane of the specimen; as this light moves past the specimen plane it spreads again into a hollow cone. The objective lens sits in the dark hollow of this cone; although the light travels around and past the objective lens, no rays enter it. The entire field appears dark when there is no sample on the microscope stage; thus the name dark-field microscopy. When a sample is on the stage, the light at the apex of the cone strikes it. As shown in FIG. 8, the image is made only by those rays scattered by the sample and captured in the objective lens (note the rays scattered by the particle in FIG. 8). The image appears bright against the dark background.

Dark-field microscopes are typically equipped with specialized condensers constructed only for dark-field application. This dark-field effect can be achieved in a brightfield microscope, however, by the addition of a simple “stop”. The stop is a piece of opaque material placed below the substage condenser; it blocks out the center of the beam of light coming from the base of the microscope and forms the hollow cone of light needed for dark-field illumination.

Dark-field microscopy reduces the amount of light entering the lens system of a microscope in two ways. First, the stop blocks the center of the beam of light that would otherwise fill the objective lens. Second, only the light which is scattered by the specimen and enters the objective lens is seen. Therefore, the best viewing result typically requires increasing the light intensity as much as possible: by setting the light intensity adjustment at maximum, by opening the field diaphragm, by opening the condenser aperture, and by removing any color or other filters. The particle container preferably holds the particle sample within the field of view of the microscope.

The use of dark-field microscopy provides rapid and direct visualization of individual particles. Accordingly, this procedure can be used to achieve high efficiency and accuracy on samples in the colloidal state. When using TEM, samples typically need to be dried on a thin film, which often results in aggregation of nanoparticles, making it difficult to determine the original particle concentration. In addition, the time and complexity for obtaining one dark-field image is orders of magnitude less than those for obtaining one TEM image. When dynamic light scattering (PCS) is used to determine the size distribution of colloidal particles, as larger particles have much greater scattering power, smaller particles can be masked. Moreover, the average size determined by PCS can contain significant error when the particles have a relatively broad size distribution.

In one embodiment, dark-field microscopy is used to directly visualize individual nanoparticles in a colloidal suspension, preferably in a transparent cell. The brightness and location of individual particles within the field of view of the dark-field microscope is recorded, for example, by a digital camera. The concentration of particles can be determined by counting the number of particles in a given suspension volume. The particle size distribution can be constructed based on the relative brightness (scattering intensity) of individual particles after the instrument is calibrated with reference particles prior to the measurement of the sample suspension. Alternatively, the reference particles can be added to the sample suspension for calibration. In addition or alternatively, the average diffusion coefficient of the particles (and their average hydrodynamic diameter) can be determined by tracking the distance traveled by individual particles over a period of time.

The schematics of dark-field detection of nanoparticles is illustrated in FIG. 8. The excitation light is illuminated at an oblique angle so that the light does not enter the detector under the normal (no particle present) condition. When a particle enters the field of view, the particle scatters light and some of the scattered light propagates toward the detector.

Preferred detectors are CCD (charge-coupled device) and CMOS (complimentary metal-oxide semiconductor) sensors. Both CCD and CMOS detectors convert light into electrons using an array of pixels. In a CCD detector, the charge produced from the detector is actually transported across the chip and read at one corner of an array. An analog-to-digital converter can then be used to turn each pixel's value into a digital value. In most CMOS devices, there are several transistors at each pixel that amplify and move the charge using more traditional wires. The CMOS approach may be more flexible because each pixel can be read individually.

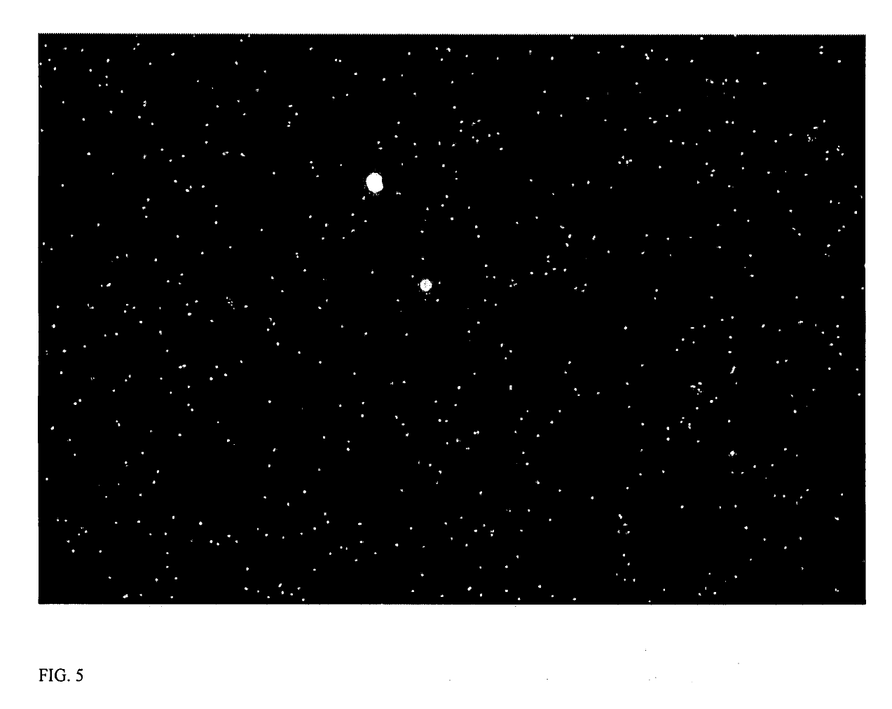

FIG. 5 shows a photo of the 60-nm diameter gold nanoparticles detected by this method. Detected nanoparticles are marked with arrows. 60 nm is not the smallest nanoparticles this detection method can detect. According to a simulation, it is expected that much smaller nanoparticles (10 nm or less) can also be detected.

The optical sample cell for confining the sample suspension during the dark-field microscopy measurements preferably has predetermined dimensions for accurately determining the sample volume. In addition, the cell is preferably thin enough so that all of the nanoparticles are within the focal volume of the objective lens. Since all particles will be within focus, the brightness of individual particles will be stable enough to allow detection and automated segmentation of particles against the background. The random Brownian motion of nanoparticles can then be recorded as digital images which can be stored onto a host computer for processing. While light microscopy provides a much simpler sample preparation as compared to TEM, dark-field illumination provides sufficient contrast for visualizing sub-resolution particles.

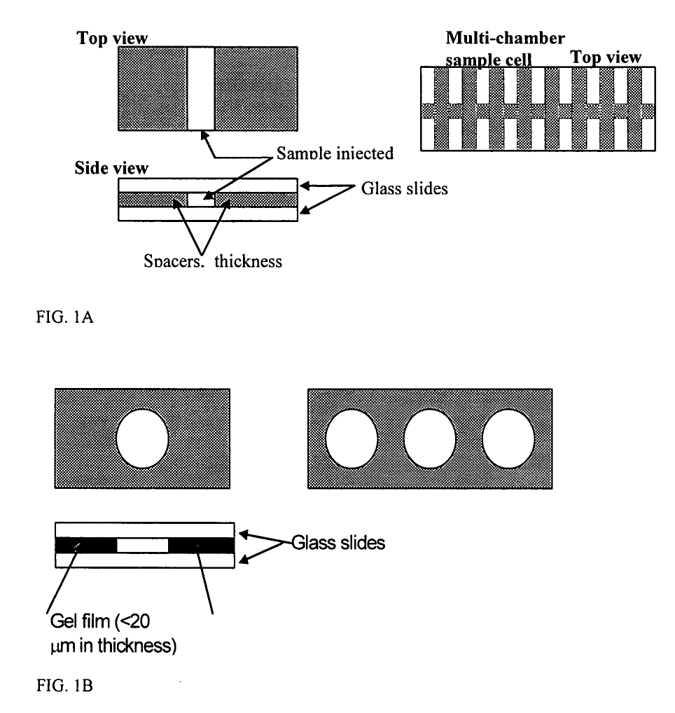

FIGS. 1A and 1B show examples of sample cell configurations for holding sample suspensions during the dark-field microscopy measurements. FIG. 1A shows an open sample cell in which spacers separate two glass slides that form the top and bottom of the cell. The spacers can be made, for example, of metal such as aluminum and steel, plastic or elastomer such as polydimethylsiloxane (PDMS). Preferably, the spacers are less than 20 μm high. The cell has channels in which a sample can be injected into from the open sides of the cells. FIG. 1A shows both a single chamber configuration including a single sample channel for containing the sample and a multi-channel configuration.

FIG. 1B shows an example of a closed cell configuration. The top and bottom of the cell can be, for example, glass slides. The sample can be confined within a volume between the cells made of a gel film having a thickness of 20 μm. The film can be made, for example, from PDMS. PDMS is soft, which allows holes to easily be punched into the material to form the chamber. The film can be placed on a glass slide, an adequate volume of sample suspension can then be placed into the chamber and then the chamber can be covered with another glass slide.

Sample images can be obtained by placing a sample on a dark-field microscope stage and adjusting the microscope for optimal dark field illumination. A CCD or CMOS camera attached to the microscope can be used to capture images.

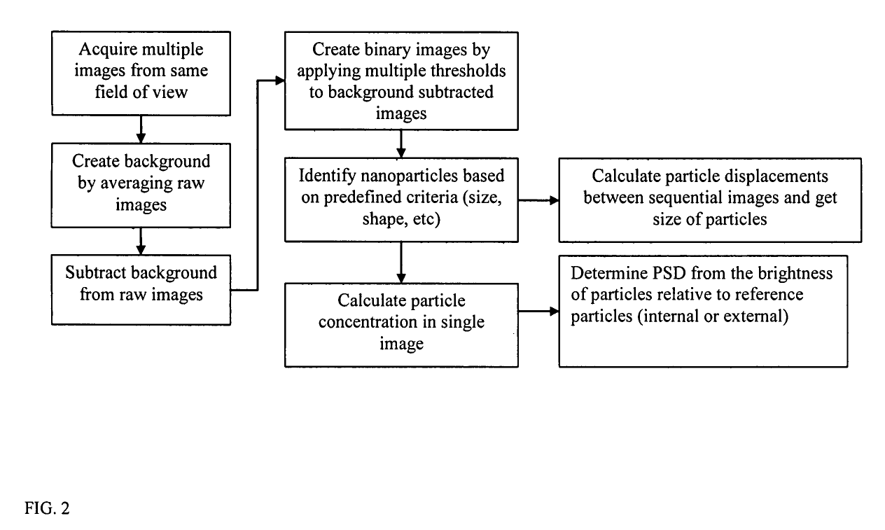

FIG. 2 shows a flow chart for pre-processing raw images and segment particles in dark-field images for determining particle number concentration and particle size distributions. First, multiple images are obtained from the sample field of view. Next, a background is created by averaging the raw images. The background is then subtracted from the raw images. Binary images are created from the raw images by applying multiple thresholds to the background subtracted images. Multiple thresholds for the binary images are preferably obtained because of the variation in brightness between nanoparticles. The binary images then go through particle analysis to identify which objects are nanoparticles based on a set of pre-defined criteria such as size and shape. The displacement of the particles between sequential images can be used to determine the size of the particles using the particles diffusion coefficient as further explained herein. Alternatively, the brightness of particles can be used to determine the size of the particles. Total number of particles in one image is divided by the volume (thickness×width×height) of the optical cell to get the PNC. PSD (percentage of particles in a given size) can be determined from recorded images by two independent approaches:

(1) Particle brightness: The scattering intensity or brightness of particles is a function of the radius (a) and refractive index (m) of particles as well as the wavelength (λ) and intensity (I₀) of the illuminating light.

$$I = β {I}_{0} \frac{{a}^{6}}{{λ}^{4}} {\vert \frac{{m}^{2} - 1}{{m}^{2} + 1} \vert}^{2} \qquad Equation 1$$

The numerical coefficient (β), which is dependent of instrumental settings, can be determined by using a reference colloidal suspension (such as monodispersed colloidal gold). A laser or a white light source with a narrow bandpass filter can be used to provide monochromatic light illumination. Then, the PSD of a given colloidal suspension can be determined based on the brightness of particles in the recorded images using the above Equation 1.

(2) Diffusion coefficient: A series of images can be taken so that the positional changes caused by the Brownian motion can be measured. From the successive displacement of particles, one can determine the diffusion coefficient of particles according the Equation 2:
D=<x²+y²>/4t Equation 2
where <x²+ y²> is the mean square distance traveled by a given particle in the x-y plane during the time interval, t, between two consecutive recorded images. Then the particle size (radius of particle, a) can be determined by Stoke-Einstein relation

$$a = \frac{kT}{6 π η D} \qquad Equation 3$$

where k is the Boltzmann constant, T is absolute temperature and ρ is viscosity of the suspending medium.

The advantage of the particle brightness approach is that the size distribution can be obtained from a single image. However, a reference standard is typically needed to calibrate the instrument. In contrast, the diffusion coefficient approach does not need instrument calibration and the intensity of the light source does not have to be constant through the measurement. However, a series of images at sufficiently short time intervals typically have to be taken.

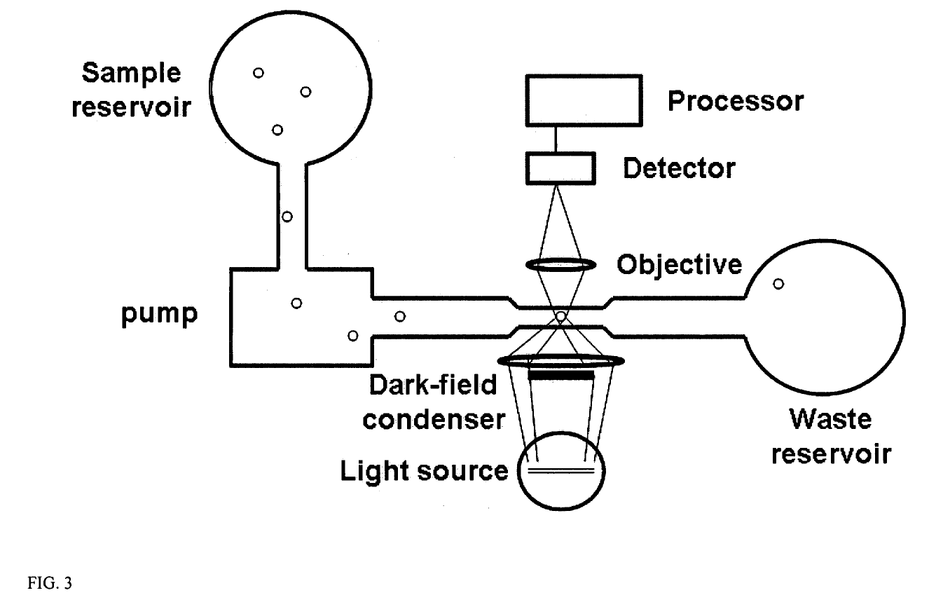

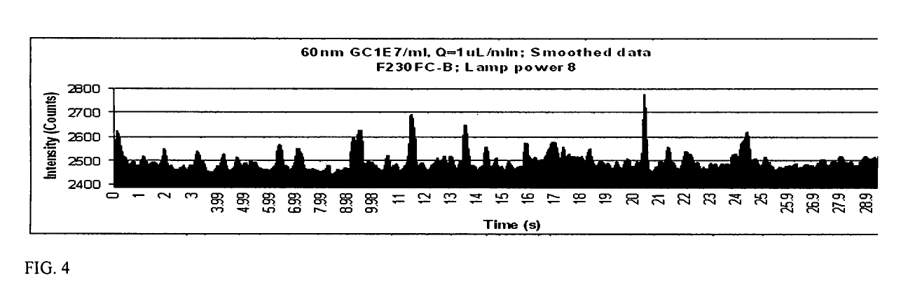

FIG. 3 shows an embodiment of a dark-field microscopy based particle counter and sizer, which allows rapid analysis of larger sample volume by using a fluidic system. In FIG. 3 a pump is used to pump a sample from a reservoir through a narrow capillary. Preferably, the capillary has an inner diameter 10 to 90 microns. A dark-field microscope that includes a dark-field condenser, a light source, an objective lens, a light detector and a processor monitors particles passing the illumination point in the narrow capillary. The scattering intensity read from the detector is processed by a microprocessor and the number and size of particles are recorded and displayed to the user. The sample is deposited into a waste reservoir once the sample has exited the narrow capillary. In this manner, a larger volume of sample can be analyzed. FIG. 4 shows a typical data of detecting nanoparticles by a continuous fluidic dark-field particle counter, when particles of average diameter 60 nanometer were flowed. Each peak is generated by a particle passing the illumination point. The particle number concentration is obtained by the number of peaks observed during a given period of time divided by the volume of fluid flowed through the capillary during the same period of time. The intensity of each peak can be used to further calculate the size of each particle detected. The size of all the particles detected can be analyzed by well known statistical methods to calculate the particle size distribution.

FIG. 5 Shows a dark-field microscopic image of 60 nm Au particles, acquired with a 10×, NA 0.3 objective. The field of view is 680 μm×450 μm. The sample cell thickness is 15 μm, measured by a confocal microscope. The error in the particle concentration obtained by using this method is less than 10%.

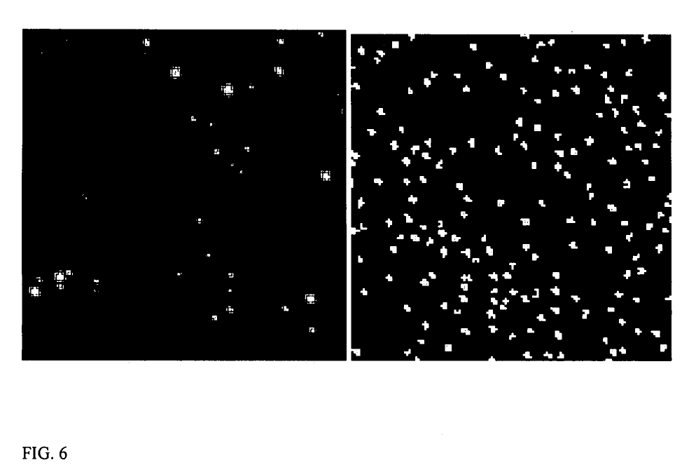

FIG. 6 shows an example of the binary images produce by applying a threshold to the original dark-field raw image of sample particles. In FIG. 6, an original image (left) is shown next to a binary image after automated particle segmentation (right). The error of automated segmentation (using manual segmentation as standard) is less than 10%.

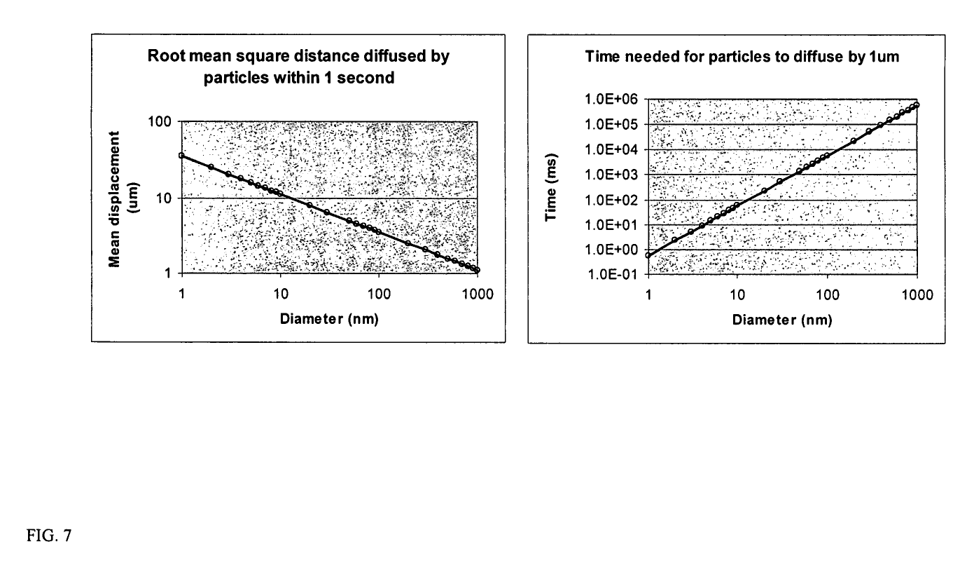

FIG. 7 shows the root mean square distance covered by diffusing particles within 1 second (left) and time needed for particles to diffuse by a distance of 1 μm (right) in aqueous solution at 25° C. The diffusion coefficients of particles of any given diameter were estimated by using Stoke-Einstein relation (Equation 3). Then Equation 2 was used to calculate the root mean square distance as a function of particle diameter at a fixed diffusion time of 1 second (left) and to calculate the time needed for particles to diffuse by 1 μm (right). These theoretical calculations help us to determine the range of particle size that can be determined by the method.

### EXAMPLE 1

Following is an example of obtaining the PSD of a sample using the diffusion coefficient of the particles. A dark-field microscope is used to obtain images with a dimension of 680×450 μm2 in 1 second intervals. It was possible to track the particle motion if the distance traveled by the particle is less than 10 μm. As can be seen in FIG. 7, the PSD can be obtained for particles with a diameter greater than 10 nm provided that the particles are bright enough to be observed. Even smaller particles may be measured if a faster camera is used to acquire and transfer the images. If a faster camera is not available, a suspending medium with a viscosity greater than water can be used for measuring particles with a diameter smaller than 10 nm. Some reagents such as ethylene glycol, sucrose and organic polymers which do not cause aggregation of the particles can be added to the aqueous suspending media to increase the viscosity. For particles greater than 10 nm, images can be recorded at greater interval (say >5 s) with sufficient accuracy on the diffusion coefficient calculation. In other words, for particles greater than 100 nm, the camera speed is no longer the limiting factor. The upper limit of particle size is governed by the sedimentation velocity of particles which is a function of particle density and the viscosity of the suspending media. Particles as large as several microns can be measured with the method provided the particle density is not too high to cause rapid sedimentation.

### EXAMPLE 2

Following is an example of determining the accuracy of quantifying the PSD of a sample using the particle brightness of the particles. The sample was a 60 nm gold colloid, not an ensemble of highly dispersed particles. Accordingly, the data collected in Table 1 allowed for an estimate of the uncertainty in measuring particle size using particle brightness. As described below, the results showed that the uncertainty level is less than 5% in particle size determination. Because only a few particles were measured, a meaningful size distribution was not obtained from the data in Table 1 below. However, it is possible to use image analysis software to determine the brightness of a larger number (e.g. over 100) of particles to determine their size distribution.)

For the sample analysis, a Nikon Eclipse ME600 microscope with a dark-field condenser lens was used to obtain images of gold colloid particles (60 nm) in suspension. A CCD camera (model ST-402ME, manufacturer SBIG) was attached to the trinocular photo port of the microscope and used to capture the images with exposure time of 40 ms.

Table 1 shows the variation in brightness of selected particles in the gold colloid suspension from 10 images taken successively with a 1 s interval. The variation in particle brightness measured from all the tracked particles is less than 32%. The uncertainty in calculated particle size is (⅙) of the brightness variation according to light scattering theory. Thus the typical uncertainty in particle size is less than 5%.

TABLE 1

| Frame | Particle 1 | Particle 2 | Particle 3 | Particle 4 |
|---|---|---|---|---|
| 1 | 10807 | 3046 | 687 | 320 |
| 2 | 8657 | 3585 | 732 | 248 |
| 3 | 9837 | 2853 | 593 | 278 |
| 4 | 8873 | 3805 | 1348 | 208 |
| 5 | 9539 | 3697 | 999 | 214 |
| 6 | 12540 | 3227 | 839 | 371 |
| 7 | 10888 | 3140 | 677 | Particle moves |
| 8 | 12705 | 2609 | 523 | out of frame |
| 9 | 11594 | 3083 | 648 | |
| 10 | 12883 | 2820 | | |
| Ave | 10832 | 3187 | 783 | 273 |
| SD | 1579 | 397 | 253 | 64 |
| CV | 15% | 12% | 32% | 23% |

The devices and methods described herein can be used for a variety of applicants, for example, in the point of care and field devices for diagnostics, forensic, pharmaceutical, agricultural, food inspection, biodefense, environmental monitoring, and industrial process monitoring.

This application discloses several numerical range limitations that support any range within the disclosed numerical ranges even though a precise range limitation is not stated verbatim in the specification because the embodiments of the invention could be practiced throughout the disclosed numerical ranges. Finally, the entire disclosure of the patents and publications referred in this application, if any, are hereby incorporated herein in entirety by reference.

1. A method of determining the particles size distribution of particles comprising:
measuring a scattering intensity of particles in a sample with a dark-field microscope; and
correlating a brightness of the particles to a particle size distribution of the particles in the sample.

2. The method of claim 1, wherein the particles have an average particle size less than 4 microns.

3. The method of claim 1, wherein the particles have an average particle size less 400 nanometers.

4. The method of claim 1, wherein the particles comprise polystyrene, latex, gold, silver, copper, iron, lithium, sodium, potassium, palladium, platinum, aluminum or a metal oxide.

5. The method of claim 1, wherein a reference sample is used to determine the correlation between the brightness of the particles and the size of the particles.

6. The method of claim 1, further comprising determining the particle number concentration of the sample.

7. The method of claim 6, wherein the particle number concentration of the sample is determined by determining the number of particles in a sample volume

8. A method of determining the particles size distribution of particles comprising:
obtaining a plurality of dark-field images with a dark field microscope of a sample comprising particles; and
correlating positional changes of the particles in the plurality of dark-field images for a given time to a particle size distribution of the particles.

9. The method of claim 8, wherein the particles have an average particle size less 4 microns.

10. The method of claim 8, wherein the particles have an average particle size less 400 nanometers.

11. The method of claim 8, wherein the particles comprise polystyrene, latex, gold, silver, copper, iron, lithium, sodium, potassium, palladium, platinum, aluminum or a metal oxide.

12. The method of claim 8, further comprising determining the particle number concentration of the sample.

13. The method of claim 12, wherein the particle number concentration of the sample is determined by determining the number of particles in the sample, determining a volume of the sample and dividing the number of particles in the sample by the volume of the sample.

14. A device comprising:
a cell having a closed volume with a thickness of 20 μm or less, wherein the closed volume is a predetermined fixed volume, and wherein the cell is transparent in a direction along the thickness; and
a dark-field microscope,
wherein the closed volume is adapted to be completely within a field of view of the dark-field microscope such that the device is adapted to determine a particle size distribution and a particle number concentration of a sample.

15. The device of claim 14, further comprising an array of cells on a single substrate.

16. The device of claim 14, further comprising a sample comprising colloidal particles within the cell.

17. The method of claim 16, wherein the colloidal particles have an average particle size less than 4 microns.

18. The method of claim 16, wherein the colloidal particles have an average particle size less than 400 nanmometers.

19. The method of claim 16, wherein the colloidal particles comprise polystyrene, latex, gold, silver, copper, iron, lithium, sodium, potassium, palladium, platinum, aluminum or a metal oxide.

20. The device of claim 14, wherein the dark-field microscope comprises a light source, an opaque disk and a condenser lens.

21. The device of claim 14, wherein the dark-field microscope comprises a charge coupled device (CCD) and a microprocessor.

22. The device of claim 14, wherein a cell wall comprises glass.

23. The device of claim 14, wherein a cell wall comprises a gel film.

24. A device comprising:
a cell having a thickness of 201 μm of less, wherein the cell is transparent in a direction along the thickness;
fluid injection channels, wherein the fluid injection channels provide cites to inject a sample into the cell, and
a dark-field microscope.

25. The device of claim 24, further comprising an array of cells on a single substrate.

26. The device of claim 24, further comprising a sample comprising colloidal particles within the cell.

27. The method of claim 26, wherein the colloidal particles have an average particle size less than 4 microns.

28. The method of claim 26, wherein the colloidal particles have an average particle size less than 400 nanmometers.

29. The method of claim 26, wherein the colloidal particles comprise polystyrene, latex, gold, silver, copper, iron, lithium, sodium, potassium, palladium, platinum, aluminum or a metal oxide.

30. The device of claim 24, wherein the dark-field microscope comprises a light source, an opaque disk and a condenser lens.

31. The device of claim 24, wherein the dark-field microscope comprises a charge coupled device (CCD) and a microprocessor.

32. The device of claim 24, wherein a cell wall comprises glass.

33. The device of claim 24, wherein a cell wall comprises a gel film.

34. The device of claim 24, wherein the cell is adapted to be completely within a field of view of the dark-field microscope such that the device is adapted to determine a particle size distribution and a particle number concentration of a sample.

35. A device comprising:
a capillary;
a pump to pump a fluid containing particles through the capillary; and
a dark-field microscope focused on the fluid in the capillary.

36. The device of claim 35, further comprising a waste reservoir for depositing the sample once the sample has exited the capillary.

37. The device of claim 35, wherein the capillary has an inner diameter of less than 90 microns.

38. The method of claim 35, wherein the particles have an average particle size of less than 4 microns.

39. The method of claim 35, wherein the particles have an average particle size of less 400 nanometers.

40. The method of claim 35, wherein the particles comprise polystyrene, latex, gold, silver, copper, iron, lithium, sodium, potassium, palladium, platinum, aluminum or a metal oxide.

41. The device of claim 35, wherein the dark-field microscope comprises a light source, an opaque disk and a condenser lens.

42. The device of claim 35, wherein the dark-field microscope comprises a charge coupled device (CCD) and a microprocessor.

43. The device of claim 35, wherein a portion of the capillary is adapted to be completely within a field of view of the dark-field microscope such that the device is adapted to determine a particle size distribution and a particle number concentration of a sample.
